(19) United States
(12) Patent Application Publication
(10) Pub. No.: US 2009/0106452 A1
(43) Pub. Date: Apr. 23, 2009

(54) ADDRESS ASSIGNMENT

(76) Inventor: Johnny A. LAM, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/875,336

(22) Filed: Oct. 19, 2007

(51) Int. Cl. G06F 15/16

(52) U.S. Cl. 709/245

(57) ABSTRACT

A system comprises a first computer comprising a first switch and a first endpoint device. The system also includes a second computer comprising a second switch and a second endpoint device. The second computer couples to the first computer. The first endpoint device receives a signal from the second endpoint device. The signal comprises a signature that identifies the second endpoint device. The signal further comprises a hop count that indicates a number of electronic devices between the first and second endpoint devices. Based on the signature and the hop count, the first endpoint device assigns an address to the second endpoint device.

### BACKGROUND

Electronic communication devices communicate with other electronic devices in networks. Often, the electronic devices identify themselves to other devices on the network using addresses (e.g., Media Access Control (MAC) addresses). Such addresses generally are assigned to the electronic devices during manufacture. Unfortunately, assigning addresses to the electronic devices during manufacture results in increased manufacture time and cost.

### BRIEF DESCRIPTION OF THE DRAWINGS

For a detailed description of exemplary embodiments of the invention, reference will now be made to the accompanying drawings in which:

FIG. 1 shows a block diagram of an illustrative system implementing the techniques disclosed herein, in accordance with various embodiments; and

FIG. 2 shows a flow diagram of an illustrative method implementing the techniques disclosed herein, in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, in the following discussion and in the claims, the term “couple” or “couples” is intended to mean either an indirect, direct, optical or wireless electrical connection. Thus, if a first device couples to a second device, that connection may be through a direct electrical connection or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

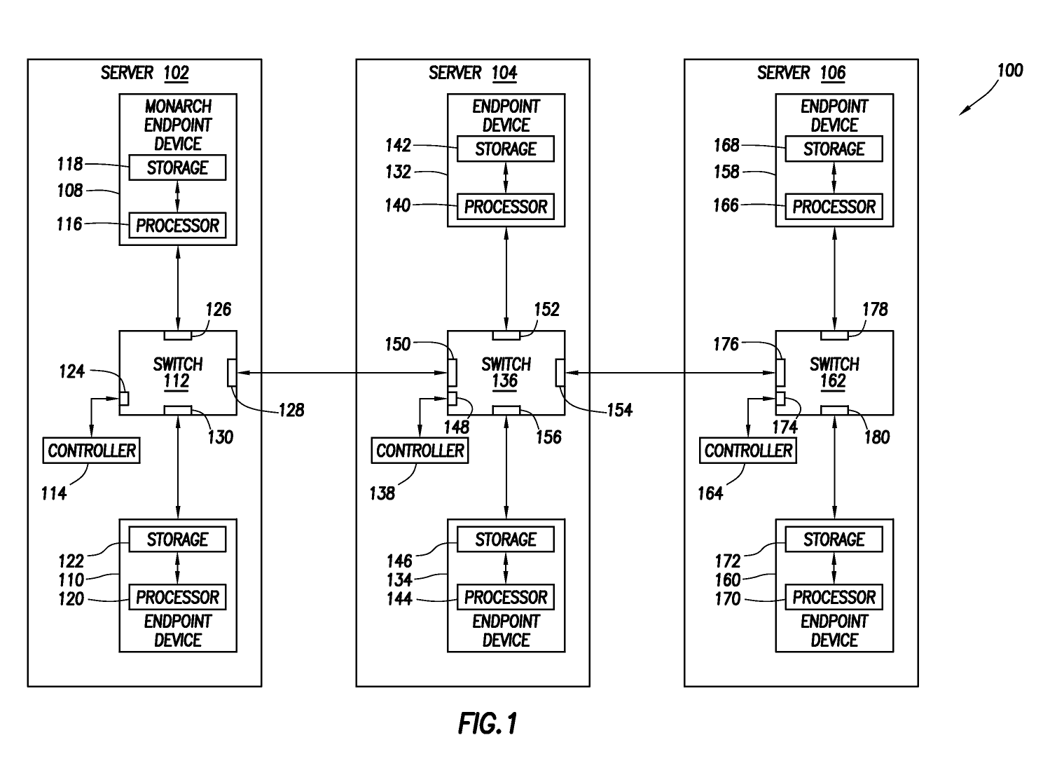

Disclosed herein is a technique by which circuit logic in a server dynamically assigns an address (e.g., Media Access Control (MAC) address, Internet Protocol (IP) address) to circuit logic in another server, where the two servers are on a common network. FIG. 1 shows a block diagram of an illustrative network 100. The network 100 may comprise, for example, an Ethernet network. The network 100 comprises multiple servers 102, 104 and 106. Although three servers are shown in FIG. 1, any number of server(s) or other networking devices may be used.

Server 102 comprises an endpoint device 108, an endpoint device 110, a switch 112 and a controller 114. The endpoint devices 108 and 110 may comprise any suitable circuit logic, such as a cell board that performs some predetermined function for the server 102. The endpoint device 108 comprises a processor 116 and storage (e.g., random access memory (RAM)) 118. Similarly, the endpoint device 110 comprises a processor 120 and storage (e.g., RAM) 122. The switch 112 couples to the controller 114 via a port 124. The switch 112 couples to the endpoint device 108 via a port 126. The switch 112 couples to the endpoint device 110 via a port 130.

Server 104 comprises an endpoint device 132, an endpoint device 134, a switch 136 and a controller 138. The endpoint device (e.g., cell board) 132 comprises a processor 140 and storage (e.g., RAM) 142. The endpoint device (e.g., cell board) 134 comprises a processor 144 and storage (e.g., RAM) 146. The switch 136 couples to controller 138 via a port 148. The switch 136 couples to the switch 112 via a port 150 (and the switch 112 couples to the switch 136 via a port 128). The switch 136 couples to the endpoint device 132 via a port 152. The switch 136 couples to the endpoint device 134 via a port 156.

Server 106 comprises an endpoint device 158, an endpoint device 160, a switch 162 and a controller 164. The endpoint device (e.g., cell board) 158 comprises a processor 166 and storage (e.g., RAM) 168. The endpoint device (e.g., cell board) 160 comprises a processor 170 and storage (e.g., RAM) 172. The switch 162 couples to the controller 164 via a port 174. The switch 162 couples to switch 136 via ports 176 and 154. The switch 162 couples to the endpoint device 158 via a port 178. The switch 162 couples to the endpoint device 160 via a port 180.

When manufactured, each of the endpoint devices in servers 102, 104 and 106 are assigned MAC addresses. These endpoint devices also may be assigned other device-specific information, such as IP addresses. These addresses and/or other device-specific information may be stored in the storage of each endpoint device. As mentioned above, in some cases, it may be desirable to assign different MAC or IP addresses or different device-specific information to one or more of the endpoint devices. Accordingly, the various embodiments disclosed herein enable the addresses or device-specific information of the endpoint devices to be dynamically re-assigned.

Re-assignment of addresses or device-specific information of the endpoint devices is performed by a supreme, or “monarch,” endpoint device that controls the remaining endpoint devices to at least some degree. An endpoint device may be designated as the monarch using any suitable technique. For example, the monarch may be designated as the monarch manually (e.g., by an end-user or Information Technology (IT) administrator) or by using a monarch-designating algorithm that compares device-specific information relating to the endpoint devices. Other suitable techniques also may be used.

Regardless of how an endpoint device is designated as the monarch, in operation, each of the endpoint devices in the servers 102, 104 and 106 broadcasts a signal to the other endpoint devices. Such broadcasting may be performed at any suitable time, such as during initialization. This signal is addressed to a broadcast address and comprises a signature (i.e., some identification information specific to that endpoint device, such as a serial number) and a hop count (described below). Additionally, each endpoint device is programmed to reject any message or signal that does not bear the signature of that endpoint device. The net effect of these operations is that, when each endpoint device broadcasts its signal, the signal is provided to most or all of the endpoint devices, but is accepted only by the monarch. Assume, for the purposes of this discussion, that the endpoint 108 has been designated as the monarch. Thus, for example, if the endpoint device 160 broadcasts a signal comprising a signature of XB3291 (its serial number), the endpoint devices 158, 132, 134 and 110 will refuse the signal because the signature XB3291 does not match any of their signatures. However, the endpoint device 108 (the monarch) is programmed to accept all such broadcast signals. As a result, the device 108 accepts the signal from the endpoint device 160.

More particularly, when the endpoint device 160 broadcasts a signal with the signature XB3291, the switch 162 initially receives this signal. The controller 164 is programmed to cause the switch 162 to capture all such signals and to route the signals to all suitable ports of the switch 162. Thus, the switch 162 captures the signal from the endpoint device 160 and distributes the signal to the endpoint device 158 and to the switch 136. Assume the endpoint device 158 has a signature of XC1235 (its serial number). Because the signatures XB3291 and XC1235 do not match, the endpoint device 158 refuses the signal.

Upon receipt of the signal by the switch 136 from the switch 162, the controller 138 causes the switch 136 to capture the signal and to distribute the signal on all suitable ports of the switch 136. Thus, the switch 136 outputs the signal to the endpoint device 132, the endpoint device 134 and to the switch 112. Assume that the signature XB3291 does not match the signatures of the endpoint devices 132 and 134. Accordingly, the devices 132 and 134 reject also the signal.

Upon receipt of the signal by the switch 112 from the switch 136, the controller 114 causes the switch 112 to capture the signal and to distribute the signal on all suitable ports of the switch 112. Thus, the switch 112 outputs the signal to the endpoint device 110 and to the endpoint device 108 (the monarch). The endpoint device 110 refuses the signal, but the monarch 108, which is programmed to accept all such signals, accepts the signal that was originally generated by the endpoint device 160.

As previously mentioned, the signal comprises a “hop count” in addition to the signature of the endpoint device 160. The hop count is a value (e.g., integer value) encoded on the signal. The hop count is incremented by each switch that handles the signal. Thus, for example, the endpoint device 160 may output the signal to the switch 162 with the signal having a hop count initialized to 0. The switch 162 increments the hop count to 1; the switch 136 increments the hop count to 2; and the switch 112 increments the hop count to 3. Therefore, when the monarch 108 receives the signal, the signal comprises the serial number XB3291 of the endpoint device 160, as well as a hop count of 3.

In addition to receiving a signal from the endpoint device 160, the monarch 108 receives similar signals from most or all of the endpoint devices in the servers 102, 104 and 106. In turn, the monarch 108 dynamically assigns addresses or other device-specific information to one or more of the endpoint devices using their respective serial number(s) and/or hop counts. The actual addresses or device-specific information may be generated in any suitable manner (e.g., randomly or in a predetermined fashion). The monarch 108 then broadcasts multiple return signals, with each return signal intended for a different endpoint device. Each return signal comprises a MAC address and/or an IP address, a signature of the intended (destination) endpoint device, the hop count and a return hop count (described below).

The MAC address encoded in the return signal is the MAC address to which the receiving endpoint device will be assigned. Similarly, the IP address encoded in the return signal is the IP address to which the receiving endpoint device will be assigned. The hop count, return hop count and serial number are collectively used by the network 100 to properly route the return signals to their intended destinations. In particular, the return hop count is incremented by each switch through which it passes. Thus, for example, a return signal from the server 102 to the server 106 may cause the return hop count to reach a value of 3. Each switch that handles a return signal determines whether the return hop count matches the original hop count. If the hop counts match, the return signal has reached the intended destination server. The switch then uses the signature to determine which of the endpoint devices in the server has a signature that corresponds to the signature of the return signal. Once a matching endpoint device is located, the MAC, IP and/or other address in the return signal is implemented in the target endpoint device. In this way, the MAC, IP or other address(es) of the endpoint device are dynamically assigned (or re-assigned).

Continuing with the previous example, assume that the endpoint device 160 broadcasts a signal with a signature of XB3291 and a hop count of 0. The signal is rejected by all endpoint devices except for the monarch 108. When accepted by the monarch 108, the hop count has increased to 3 and the signature remains XB3291. The monarch 108 generates a return signal intended for the endpoint device 160. The return signal comprises an illustrative MAC address of 001100110011. The return signal comprises an illustrative IP address of 110011001100. In this illustrative example, both the MAC and IP addresses are generated for the target endpoint device. The return signal comprises a signature of XB3291. The return signal comprises a hop count of 3 and a return hop count of 0. The monarch 108 broadcasts this return signal. The return signal is propagated through the network 100 to each of the endpoint devices. Because only the endpoint device 160 has a serial number XB3291 that matches that of the return signal, all other endpoint devices reject the return signal. However, to ensure that the correct endpoint device accepts the return signal, the hop count is repeatedly compared to the return hop count (the return hop count is incremented by each switch through which the return signal passes). When the hop count matches the return hop count, it is understood that the return signal is “in” the correct server. Thus, when the hop count matches the return hop count, and when the signature of the return signal matches that of an endpoint device, it is ensured that that endpoint device is the intended recipient of the return signal. The MAC address of 001100110011 and the IP address of 110011001100 are implemented in that endpoint device.

More precisely, when the return signal is broadcast by the monarch 108, the switch 112 increments the return hop count to 1, the switch 136 increments the return hop count to 2, and the switch 162 increments the return hop count to 3. At this point, the hop count (value of 3) matches the return hop count (value of 3). Thus, the return signal is “in” the server housing the intended recipient of the return signal. The signature of the return signal, XB3291, is then compared to the signatures of the endpoint devices in the server 106. Because the endpoint device 160 is the only endpoint device in the server 106 that has a signature (XB3291) that matches the signature in the return signal, the endpoint device 160 is the intended recipient of the return signal and the return signal is provided to the endpoint device 160 for implementation. The hop count comparisons and increments, as well as the signature comparisons, are made by the switch controllers using hop count and signature information stored in the switches or switch controllers.

In some embodiments, however, hop counts and signatures may be compared using a different technique. In particular, when a return signal is broadcast by the monarch 108, the return hop count is incremented by each switch that handles the return signal. Each switch also determines whether, after incrementing the return hop count, the hop count and return hop count match. If they match, that switch does not forward the return signal to any other switches, because the switch has determined that the return signal is intended for an endpoint in the server corresponding to that switch. Instead of forwarding the return signal, the switch distributes the return signal to each of the endpoints in the server to which the switch corresponds. In turn, the endpoints that receive the return signal compare their signatures (e.g., serial numbers) to the signature on the return signal. If an endpoint device determines a match exists, that endpoint device accepts the return signal and implements the addresses or other device-specific information encoded on the return signal.

For example, when a return signal broadcast by the monarch 108 and intended for the endpoint device 160 reaches switch 112, the switch 112 increments the return hop count to a value of 1. The switch 112 then compares the hop count (3) to the return hop count (1). Because they do not match, the switch 112 forwards the return signal to the switch 136. The switch 136 increments the return hop count to a value of 2 and, determining that the hop count and return hop count still do not match, the switch 136 forwards the return signal to the switch 162. The switch 162 increments the return hop count to a value of 3. Upon comparing the hop count (3) to the return hop count (3), the switch 162 determines that the endpoint device for which the return signal is intended is in server 106. Accordingly, the switch 162 distributes copies of the return signal to both the endpoint devices 158 and 160. The endpoint device 158 compares its signature to the signature on the return signal (i.e., XB3291). Because the signatures do not match, the endpoint device 158 refuses the return signal. However, the endpoint device 160 compares its signature (i.e., XB3291) to the signature on the return signal (i.e., XB3291). Because the signatures match, the endpoint device 160 accepts the return signal and implements the addresses encoded on the return signal.

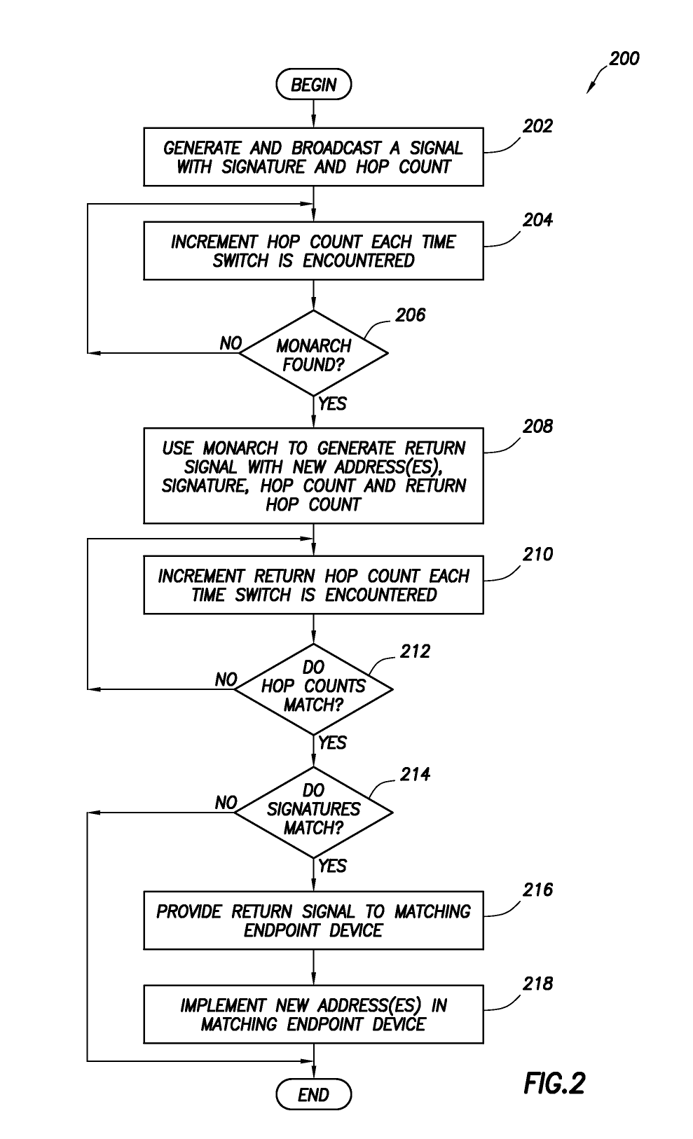

FIG. 2 shows a flow diagram of an illustrative method 200 implemented in accordance with various embodiments. The method 200 comprises generating and broadcasting a signal with an endpoint device's signature and an initialized hop count (e.g., hop count of 0) (block 202). The method 200 comprises incrementing the hop count each time a switch is encountered (block 204). If the monarch is found (block 206), the method 200 comprises using the monarch to generate a return signal with new address(es), signature, hop count and initialized return hop count (e.g., hop count of 0) (block 208). The method 200 comprises incrementing the return hop count each time a switch is encountered (block 210). The method 200 then comprises repeatedly determining whether the hop count matches the return hop count (block 212). If so, the method 200 comprises determining whether the return signal signature matches the signature of an endpoint device local to the current server (block 214). If so, the method 200 comprises providing the return signal to the matching endpoint device (block 216) and implementing new address(es) in the matching endpoint device (block 218). The various portions of the method 200 may be performed in any suitable order and are not limited to being performed in the order shown in FIG. 2.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a first computer comprising a first switch and a first endpoint device; and
a second computer comprising a second switch and a second endpoint device, the second computer coupled to the first computer;
wherein the first endpoint device receives a signal from the second endpoint device, the signal comprising a signature that identifies said second endpoint device, the signal further comprising a hop count that indicates a number of electronic devices, between the first and second endpoint devices, through which the signal passes;
wherein, using said signature and said hop count, the first endpoint device assigns an address to the second endpoint device.

2. The system of claim 1, wherein the first endpoint device comprises a monarch device that at least partially controls the second endpoint device.

3. The system of claim 1, wherein the first endpoint device transfers a response signal comprising said address, said hop count and a return hop count to the second endpoint device, and wherein the return hop count is incremented each time the response signal passes through a switch, and wherein the second switch determines that the address corresponds to said second computer by comparing the hop count to the return hop count, and wherein the second endpoint device determines that the address corresponds to the second endpoint device by comparing the signature to another signature encoded in the response signal.

4. The system of claim 1, wherein the address comprises either a Media Access Control (MAC) address or an Internet Protocol (IP) address.

5. The system of claim 1, wherein said hop count indicates a number of switches between the first and second endpoint devices.

6. The system of claim 1, wherein said signature comprises a serial number associated with said second endpoint device.

7. The system of claim 1, wherein the first endpoint device sends a return signal comprising the address to the second endpoint device, and wherein said first and second switches and another switch between the first and second switches use the hop count to transfer the assignment signal from the first endpoint device to the second endpoint device.

8. The system of claim 1, wherein, using said signature and hop count, the first endpoint device assigns another address to the second endpoint device,
wherein the address comprises a Media Access Control (MAC) address and said another address comprises an Internet Protocol (IP) address.

9. A system, comprising:
an endpoint device; and
a switching device coupled to the endpoint device;
wherein the switching device receives a signal comprising identification and a hop count and provides the signal to the endpoint device, the identification identifies an electronic device external to the system and the hop count indicates a location of the endpoint device relative to the electronic device;
wherein the endpoint device assigns an address to the electronic device using the identification and the hop count.

10. The system of claim 9, wherein the endpoint device is adapted to control the electronic device.

11. The system of claim 9, wherein the system comprises a server.

12. The system of claim 9, wherein said identification comprises a serial number.

13. The system of claim 9, wherein the address comprises either a Media Access Control (MAC) address or an Internet Protocol (IP) address.

14. The system of claim 9, wherein the endpoint device assigns said address based on said identification, wherein the identification comprises a serial number.

15. A method, comprising:
providing a first signal comprising a signature and a hop count to a first electronic device, the signature identifies a second electronic device and the hop count indicates a number of electronic devices between the first and second electronic devices; and
using the signature and the hop count to assign an address to the second electronic device.

16. The method of claim 15, wherein the address is selected from the group consisting of a Media Access Control (MAC) address and an Internet Protocol (IP) address.

17. The method of claim 15, wherein the first electronic device and the second electronic device are housed in separate servers.

18. The method of claim 15, wherein said signature comprises a serial number.

19. The method of claim 15, wherein said first electronic device comprises a monarch that controls the second electronic device.

20. The method of claim 15 further comprising:
comparing said hop count to a return hop count that is incremented each time a return signal comprising the return hop count passes through a switch on the way from the first electronic device to the second electronic device; and
comparing said signature to another copy of said signature of the second electronic device;
wherein, based on said comparison of hop counts and said comparison of signatures, providing said return signal to the second electronic device.
